(19) United States
(12) Patent Application Publication
(10) Pub. No.: US 2006/0276363 A1
(43) Pub. Date: Dec. 7, 2006

(54) CARPET TREATING COMPOSITION

(75) Inventors: Alessandro CAGNINA, Mira (IT); Zefferino RIGHETTO, Mira (IT)

Correspondence Address: Andrew N. Parfomak;Norris McLaughlin & Marcus PA, 875 Third Avenue, 18th Floor, New York, NY, 10022, US

(73) Assignee: RECKITT BENCKISER N.V., Hoofddorp (NL)

(21) Appl. No.: 11/427,120

(22) Filed: Jun. 28, 2006

(30) Foreign Application Priority Data
Jan. 6, 2004 (GB) 0400118.6
Dec. 24, 2004 (WO) PCT/GB04/05411

(51) Int. Cl. C11D 17/00

(52) U.S. Cl. 510/284

(57) ABSTRACT

A two-compartment dispenser comprising a first compartment containing an aqueous composition comprising hydrogen peroxide or an organic peracid and a second compartment containing an alkalizing agent additionally comprise sufficient surfactant, including any super wetting agent, the two compartment containing sufficient surfactant (and super wetting agent, if present) to achieve a surface tension of below 28 mN/m upon mixing.

This invention relates to an improved process for the removal of stains from carpet and to compositions used in such processes.

A problem associated with cleaning carpets is the high repellancy of the carpet to water. This is primarily caused from two sources, the first being the amount of soiling which can accumulate on carpets and, secondly, the prevalence of stain repelling treatments which are increasingly commonly applied to carpets either during manufacture or by the consumer. In this invention it is important that a particular water tension decrease is achieved in the cleaning composition, preferably by the addition of a “super wetting” agent, to achieve satisfactory cleaning performance.

In addition stains may have been left on the carpet for some time prior to the owner tackling them. This means that the stain can be difficult to remove. Powerful cleaning action is needed, but without damage to the fibres or colour of the carpet.

The use of oxygen bleaches, with or without enzymes, in compositions for the removal of stains from carpet has been known for a long time and many such compositions are available. However, a common difficulty in formulating such a composition is to ensure that the bleach remains stable during storage but is sufficiently active on use. This is particularly difficult to achieve in liquid compositions. As described above, powerful stain removal is required in removing stains from carpets.

One solution to the problem of weak bleaching performance has been to formulate liquid peroxygen bleaches at a pH of between about 3 and 7 to produce a stable composition, but such compositions do not provide sufficient bleaching power to be useful for many household situations. Attempts have, therefore, also been made to formulate liquid peroxygen bleach compositions at pH above this range to improve their performance. However, these generally require expensive stabilising compounds to prevent loss of activity after manufacture.

The present invention provides a peroxide or peracid bleach product which has acceptable stability of the peroxide or peracid during storage, but which is capable of providing effective stain removal power when used by the consumer.

WO 9731095 describes an apparatus for claiming surfaces that contains two liquids that are mixed upon delivery to the surface. The first liquid contains a hypohalite bleach. The second liquid has a chelating agent or a builder. The pH on mixing of the two liquids is about 11.

We have found good cleaning performance of spot stains on carpet is achieved by providing two separate compositions that are mixed during, before or after, (preferably during or before application), have excellent stability and performance.

According to the invention there is provided a process for stain removal on a carpet, comprising applying to the carpet a mixture of at least two agueous compositions:
(a) an aqueous composition comprising a source of active oxygen having a pH of greater than o but less than 7 [hereinafter component (a)] and
(b) an aqueous composition [hereinafter component (b)] comprising an alkalising agent.

Preferably components (a) and/or (b) additionally comprise sufficient surfactant, including any super wetting agent, to achieve a surface tension of the combined composition of below 28 mN/m.

The use of the term carpet includes rugs, mats and runners.

Preferably both (a) and (b) do not contain an enzyme.

pH

The pH of component (a) is preferably less than 7, ideally less than 6.5, 5.0, 4.5, 4.01 3.5 or 3.0. Ideally the pH is at least 1.0, 1.5, 2.0 or 2.5.

The pH of component (b) is preferably greater than 7, ideally greater than 7.5, 8.0, 8.5, 9.0 or 9.5, Ideally the pH is less than 12.0, 11.5, 11.0, 10.5, 10.0 or 9.5.

The pH of either (a) or (b) can be adjusted by the addition of a suitable acid or base.

The pH of the mixture of (a) and (b), assuming a mixture of between 0.8:1 to 1:0.8, is at least 6.2, 6.4, 6.6, 6.8, 7.0, 7.2, 7.4, 7.6, 7.8, 8.0, 8.2, 8.4 or 8.6.. Ideally the pH on mixing is less than 11.0, 10.8, 10.6, 10.4, 10.2, 10, 9.8, 9.6, 9.4, 9.2, 9.0, 8.8, 8.6 or 8.4.

Alkalising Agent

Preferably component (b) contains an alkalising agent. An alkalising agent is a compound or mixture of compounds that can increase the pH of the resultant mixture of (a) and (b) to a pH of >6.0, ideally >6.5, >7.0, >7.5 or >8.0. Preferably the alkalising agent produces a pH of <0.0 or <1.0 The alkalising agent ideally comprises a base. Suitable bases are selected from hydroxides, carbonates, bicarbonates, sequicarbonates, hydroxides, and silicates

Therefore, the pH of component (b) is preferably higher than the pH of component (a).

Ideally, an alkaline buffering means is also present. An alkaline buffering means at a level of from 0.1% to 10% by weight of component (b). Preferably, component (b) herein comprise from 0.2% to 8% by weight of the total composition of a pH buffering means or a mixture thereof, preferably from 0.3W to 5%, more preferably from 0.3% to 3% and most preferably from 0.3% to 2%.

By “alkaline buffering means”, it is meant herein any compound which when mixed with component (a) makes the resulting solution able to resist an increase in hydrogen ion concentration.

Preferred alkaline buffering means for use herein comprise an acid having its pK (if only one) or at least one of its pKs in the range from 7.5 to 12.5, preferably from 8 to 10, and its conjugated base.

pK is defined according to the following equation:
pK=−logK
where K is the Dissocation Constant of the weak acid in water and corresponds to the following equation:
[A][H]/[HA]=K
where HA is the acid and A is the conjugated base.

The weak acid (HA) and its conjugate base (A) are in equilibrium in the compositions of the present according to the equation: KA A+H (hydrogen ions).

Preferably the alkaline buffering means herein consists of the weak acid as defined herein and its conjugate base at a weight ratio of the weak acid to its conjugate base of preferably 0.1:1 to 10:1, more preferably 0.2:1 to 5:1. Highly preferred ratio of the weak acid to its conjugate base is 1 since this is the best combination to achieve optimum buffering capacity.

Preferably a given pH buffering means herein will be used to buffer compositions having a pH between pH=pK−1 and pH=pK+1 of each of its pK.

Suitable pH buffers are formed from acid addition salts of bases that have a pKb within 1 unit of the pH of component (b). Suitable buffering systems are selected from: carbonate/bicarbonate, citric acid/citrates, borate/boric acid or phosphates/phosphoric acid or any other buffer systems described in literature.

Preferably component (a) does not have a pH buffer present. Ideally only component (b) has a pH buffer.

Source of Active Oxygen

An essential ingredient is a source of active oxygen. A preferred source according to the present invention is hydrogen peroxide or sources thereof. As used herein a hydrogen peroxide source refers to any water-soluble.source of hydrogen peroxide. Suitable water-soluble sources of hydrogen peroxide for use herein include percarbonates, organic or inorganic peroxides and perborates.

Hydrogen peroxide or sources thereof provide from 0.1% to 15%, preferably from 0.5% to 10%, most preferably from 1% to 5% by weight of the total composition of active oxygen in said composition.

As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources according to the present invention increase the ability of the compositions to remove oxidisable stains, to destroy malodorous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide”, W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxides dilauroyl peroxide, dicumyl peroxide, persulphuric acid and mixtures thereof. The compositions according to the present invention comprise from 0% to 15%, preferably from 0.005% to 10%, by weight of the total composition of said organic or inorganic peroxides.

Suitable preformed peroxyacids for use in the compositions according to the present invention include diperoxydodecandioic acid DPDA, magnesium perphthalatic acid, perlauric acid, perbenzoic acid, diperoxyazelaic acid and mixtures thereof. The compositions according to the present invention comprise from 0% to 15%, preferably from 0.005% to 10%, by weight of the total composition of said preformed peroxyacids.

Optionally, the compositions may additionally comprise from 0% to 30%, preferably from 2% to 20% of peracid precursors, i.e. compounds that upon reaction with hydrogen peroxide product peroxyacids. Examples of peracid precursors suitable for use in the present invention can be found among the classes of anhydrides, amides, imides and esters such as acetyl triethyl citrate (ATC) described for instance in EP 91 87 0207, tetra acetyl ethylene diamine (TARD), succinic or maleic anhydrides.

Super Wetting Agent

A super wetting agent is capable of reducing the surface tension in water to values below 25 mN/m at concentrations of 0.001-0.3% w/v, preferably between 0.001 and 0.1% w/v.

Preferred levels in the final mixed composition are between 0.01 and 0.03% wt.

Examples of super wetting agents of this invention are silicone glycol copolymers and flurosurfactants. The silicone glycol copolymers are described by the following formula 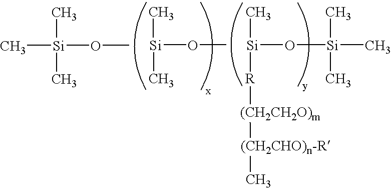
wherein x, y, m and n are each an integer ranging from 0 to 25 (X is preferred between 0-10 and y, m and n between 0-5); R and R′ are either a straight or branched alkyl chain having from 1 to 25 carbon atoms, saturated or unsaturated, and the longest linear portion of the alkyl is chain is 15 carbon atoms or less on the average.

The fluorinated surfactant is described in the following formulae:
F(CF₂)ₙ—CH₂CH₂—S—CH₂CH₂—COOM
F(CF₂)ₙ—N(CH₃)(CH₂)₃—(CH₂CH₂O)ₓOSO₂M
CF₃(CF₂CF₂)ₙ(CFCF)ₘ—(CH₂CH₂O)ₓ—OPO₃M₂

Wherein n, m and x are each integers having a value from 0 to 15; preferred values are between 1 and 12. M is a cation capable of making the compound water soluble, especially an alkali metal such as sodium or magnesium, or an ammonium or substituted ammonium cation.

Antifoaming

Antifoaming agents are an important addition to carpet cleaning compositions of this invention when the compositions are medium carpet cleaning machines, they are used at a level between 0.01 and 5% wt. A very high foam level may not allow the carpet cleaning machine to function properly and tends to reduce the mechanical action of the carpet cleaner machine brushes, thus having a detrimental impact on soil removal. Antifoaming agents are also considered important components of this invention. Examples are polydimethylsiloxanes, preferably in combination with hydrophobic silica.

In yet another aspect of the present invention, an effervescent system comprising an effervescent agent-containing component, preferably a base, is within component (b), such that when mixed with the acidic pH of component (a) generates effervescence. In such a system the pH upon mixing (a) and (b) should, ideally, be less than 7.0.

Effervescence

In one preferred embodiment of the invention an effervescent effect is achieved upon mixing (a) and (b). The effervescent agent containing component preferably comprises a base, preferably present at a level of from about 1% to about 10%, more preferably from about 2% to about 5% by weight of the compositions of the present invention. Preferably the effervescent agent is in component (b).

Suitable bases for use in the effervescent agent-containing component are selected from carbonates, bicarbonates, sesquicarbonates and mixtures thereof. Preferably, the base is selected from the group consisting of sodium carbonate, potassium carbonate, lithium carbonate, magnesium carbonate, calcium carbonate, ammonium carbonate, mono-, di-, trn-or tetra-alkyl or aryl, substituted or unsubstituted, ammonium carbonate, sodium bicarbonate, potassium bicarbonate, lithium bicarbonate, magnesium bicarbonate, calcium bicarbonate, ammonium bicarbonate, mono-, di-, tri- or tetra-alkyl or aryl, substituted or unsubstituted, ammonium bicarbonate and mixtures thereof.

The most preferred bases are selected from the group consisting of sodium bicarbonate, monoethanol-ammonium bicarbonate and mixtures thereof.

In another preferred embodiment, the effervescent agent preferably comprises a peroxide reducing enzyme that is held within component (b), such as peroxidase, laccase, dioxygenase and/or catalase enzyme, preferably catalase enzyme, preferably present at a level of from about 0.001% to about 10%, more preferably, from about 0.01% to about 5%, even more preferably from about 0.1% to about 1%, most preferably from about 0.1% to about 0.3% by weight of the compositions of the present invention. Catalase enzyme is commercially available from Biozyme Laboratories under the trade name Cat-lA, which is a bovine liver derived catalyse enzyme; from Genencor International under the trade name Oxy-Gone 400, which is a bacterial derived catalyse enzyme; and from Novo Nordisk under the trade name Terminox Ultra 50L.

Quick Breaking Foam

The effervescence system linked with the presence of surfactant is likely to produce foam upon mixing component (a) with component (b). However, it is not always desirable that the foam is one that is stable since this may mean that the foam is difficult to rinse away or obscures from the user the cleaning effect of the compositions.

Therefore, as a further feature of the invention the surfactant is selected from those that are capable of producing breaking foams. Preferably the foam breaks within 5 minutes of generation after application to the. surface, ideally less than 5, 4, 3, 2, or 1 minute. Preferably the foam does not break for at least 30 seconds, 1, 2 or 3 minutes. By the use of the term “break or breaks” we mean that at least 50 e of the volume of foam generated by the mixing of component (a) and (b) has disappeared without any form of physical or chemical intervention.

Preferred surfactants to produce capable of performing a break are:

Anionic Surfactant

Preferred anionic surfactants capable of producing a breaking foam are ethoxylated alkyl sulfates of the formula:
RO(C₂H₄O)ₙSO₃⁻M⁺

wherein R is a C₈-C₂₀ alkyl group, preferably C₁₀-C₁₈ such as a C₁₂-C₁₆, n is at least 4, for example from 4 to 20, preferably 4 to 9, especially 4 to 6, and M is a salt-forming cation such as lithium, sodium, potassium, ammonium, alkylammonium or alkanolammonium.

Nonionic Surfactants

Preferred nonionic surfactants capable of producing a breaking foam are fatty alcohol ethoxylates, especially those of formula:
R(C₂H₄O)ₙOH

wherein R is a straight or branched C₈-C₁₆ alkyl group, preferably a C₉-C₁₅, for example C₁₀-C₁₄, alkyl group and n is at least 4, for example from 4 to 16, preferably 4 to 12, more preferably 4 to 10.

Preferably the HLB value is greater than 9, ideally greater than 10.

The ethoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made 5 from alcohols of 12 to 15 carbon atoms and which contain about 7 moles of ethylene oxide. Such materials are commercially marketed under the trademarks Neodol 25-7 and Neodol 23-6.5 by Shell chetical Company.

An additional or alternative group of preferred nonionic surfactants are the polyoxyalkylated non-ionics of formula:
R¹O[CH₂CH(R³)O]_{x[CH}₂]ₖCH(OH)[CH₂]ⱼOR²

wherein R3 and R² represent linear or branched chain, saturated or unsaturated, aliphatic or aromatic hydrocarbon groups with 1-30 carbon atoms (presently 1 to 10) or one of RE and R² may be a hydrogen, R³ represents a hydrogen atom or a methyl group, x is a value between 2 and 30 and, k and j are values between 1 and 12, preferably between 1 and 5. R¹ and R² are preferably linear or branched chain, saturated or unsaturated, aliphatic or aromatic hydrocarbon groups with 6-22 carbon atoms, where group with 8 to 18 carbon atoms are particularly preferred. Particularly preferred values for x are comprised between 2 and 20, preferably between 4 and 15.

When x=2 or 3, the group R³ could be chosen to build ethylene oxide (R³═H) or propylene oxide (R³=methyl) units which can be used in every single order for instance (PO) (EO) (EO), (EO) (PO) (EO), (EO) (EO) (PO), (EO) (EO) (EO), (PO) (EO) (PO), (PO) (PO) (EO) and (PO) (PO) (PO). The value 2 or 3 for x is only an example and bigger values can be chosen whereby a higher number of variations of (EO) or (PO) units would arise.

Alternatively when x=2 or 3, the group R³ could be chosen to build ethylene oxide (R³═H) or propylene oxide (R³=methyl) units which can be used in every single order for instance (EO) (EO) (EO), (PO) (PO) (PO), (PO) (EO) (PO), (EO) (PO) (EO), (PO) (PO) and (EO) (EO). The value 2 or 3 for x is only an example and bigger values can be chosen whereby a higher number of variations of (EO) or (PO) units would arise.

Particularly preferred polyoxyalkylated alcohols of the above formula are those where k=1 and j=1 originating molecules of simplified formula:
R¹O [CH₂CH (R³) O]ₓCH₂CH(OH)CH₂OR². A suitable example is Biodac 232, available from Condea or Berol 185 from Akzo Nobel.
   Surfactant

Preferably, the total amount of surfactant is found at levels of 0.1 to 25% wt, ideally from 1 to 10% wt, on either or both liquid compositions.

Ideally sufficient surfactant is present in each composition (a) or (b) or (a) and (b), such that upon mixture of (a) and (b) the critical micelle concentration (CMC) is reached, i.e. the level above which the formation of micelles occurs [typically measured by a change in physical properties, i.e. turbidity or conductivity].

Preferably non-ionic surfactants are used. Examples of non-ionic surfactants are fatty acid alkoxylates, such as fatty acid ethoxylates, especially those of formula:
R(C₂H₄O)ₙOH
wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

The alkoxylated fatty alcohol non-ionic surfactant will frequently have a hydrophilic-lipophilic balance (HLB) which ranges from 3 to 17, more preferably from 6 to 15, most preferably from 7 to 13.

Examples of fatty alcohol ethoxylates are those made from alcohols of 12 to 15 carbon atoms and which contain about 7 moles of ethylene oxide. Such materials are commercially marketed under the trademarks meodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₁₂-C₁₅ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol non-ionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₅ linear secondary alkanol with 7 moles of ethylene oxide and Tergitol 15-S-9 is the same but with 9 moles of ethylene oxide.

Other suitable alcohol ethoxylated non-ionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further non-ionic surfactants are, for example, C₁₀-C₁₈ alkyl polyglycosides, such as C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type,

The surfactant can also be an anionic surfactant. Such anionic surface active agents are frequently provided in a salt form, such as alkali metal salts, ammonium salts, amine salts, aminoalcohol salts or magnesium salts. Contemplated as useful are one or more sulfate or sulfonate compounds including: alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N acyl taurates. Generally, the alkyl or acyl radical in these various compounds comprise a carbon chain containing 12 to 20 carbon atoms.

Particularly preferred are alkyl sulphate anionic surfactants. Most preferred are the non-ethoxylated C₁₂-₁₅ primary and secondary alkyl sulphates, especially sodium lauryl sulfate.

Polymer

Suitable polymers are those that are water-soluble and include polycarboxylate polymer (such as those that can be purchased by Rohm and Haas under the Acusol 445N name) and polycarboxylic acid copolymers (such as can be purchased under the Sokalan CP9 name by BASF)

Compositions suitable for carrying out the invention may be provided as separate components suitable for mixing-by the consumer. Where the compositions are suitable for mixing they may be mixed either directly at the surface or remote from the surface before application.

Stabilising Agent

Suitable stabilising agents for the source of active oxygen, in particular hydrogen peroxide, include chelating agents, radical scavengers, antioxidants and mixtures of any thereof.

1. Chelating Agent

The compositions of the present invention may comprise a chelating agent or a mixture thereof as a preferred optional ingredient. Suitable chelating agents may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof. The chelating agents inactivate the metal ions present on the surface of the fabrics and/or in the cleaning compositions (neat or diluted) that otherwise would contribute to the radical decomposition of any peroxygen bleach.

Suitable phosphonate chelating agents to be used herein may include alkali metal ethane 1-hydroxy diphosphonates (HEDP) also known as ethydronic acid, alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta. methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP or ethydronic acid). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy -3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the compositions according to the present invention comprise up to 5% by weight of the total composition of a chelating agent, or mixtures thereof, preferably from 0.01% to 1.5% by weight and more preferably from 0.01% to 0.5%.

2. Radical Scavenger

The compositions of the present invention may comprise a radical scavenger or a mixture thereof. Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-me-thyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®. Radical scavengers when used, are typically present herein in amounts ranging from up to 10% by weight of the total composition and preferably from 0.001% to 0.5% by weight.

3. Antioxidant

The compositions according to the present invention may further comprise an antioxidant or mixtures thereof. Typically, the compositions herein comprise up to 10% by weight of the total composition of an antioxidant or mixtures thereof, preferably from 0.002% to 5%, more preferably from 0.005% to 2%, and most preferably from 0.01% to 1%.

Suitable antioxidants to be used herein include organic acids like citric acid, ascorbic acid, tartaric acid, adipic acid and sorbic acid, or amines like lecithin, or aminoacids like glutamine, methionine and cysteine, or esters like ascorbil paimitate, ascorbil stearate and triethylcitrate, or mixtures thereof. Preferred antioxidants for use herein are citric acid, ascorbic acid, ascorbil palmitate, lecithin or mixtures thereof.

Such stabilising agent(s) may be present typically in an amount of 0 to 8 weight %, ideally 0.5 to 6 weight %, of the first aqueous composition.

Other Components

The overall composition of the dispenser or each of the first and/or second aqueous compositions may further contain up to 10, 5 or 1 weight % of at least one component selected from a fragrance, dye, germicide, preservative and corrosion inhibitor. Mixtures of two or more of such components may also be included. Such components may be contained in the first aqueous composition and/or the second aqueous composition. Alternatively, such compositions may be contained in a separate compartment of the dispenser, as described in further detail below.

Water

Water may be present in the each composition of the dispenser in an amount of 0 to up to 100 weight %, preferably, 1 to 99 or 50 to 99 weight %, more preferably, 50 to 98 or 75 to 98 weight %, for example, 80 to 97 weight % of the composition.

Dispensers

As mentioned above, the first aqueous composition and the second aqueous composition may be dispensed as a mixture. Preferably, the first aqueous composition and second aqueous composition are mixed immediately prior to or as they are being applied be applied to a surface.

The dispenser of the present invention may optionally comprise means for dispensing a mixture of at least part of the contents of the first compartment and at least part of the contents of the second compartment. Preferably, the two compositions are pre-mixed prior to being delivered onto a surface.

In an alternative embodiment, the two compositions may be directed to a common target. Thus, the dispenser preferably comprises means for directing the first aqueous composition and the second aqueous composition to a common target. The two compositions may be mixed as they are being delivered to the target. Alternatively, the user may be required to mix the compositions once the two compositions have been delivered to the target surface.

Alternatively the composition may be mixed in a carpet cleaning machine or mixed from two separate liquid reservoirs in a specially modified machine such that the machine mixes the compositions just prior to application.

Suitable multi-component dispensers include squeezy dispensers, gravity driven dispensers and spray dispensers. Examples of such dispensers are described in U.S. Pat. No. 5,765,725, WO 01/85595 and EP 0,479,451, respectively.

The dispenser of the present invention contains at least two compartments. The dispenser may contain at least one further compartment.

Component (a) preferably comprises hydrogen peroxide or peracetic acid.

In accordance with the invention the two components (a) and (b) may be mixed in any suitable proportions, depending upon their initial concentrations, suitably is such that the finalsly applied mixture comprises 0.01-30% w/w of hydrogen peroxide or an organic peracid. Preferably, the ratio of component (a) to component (b) is from 10:1 to 1:10, most preferably from 2:1 to 1:2, ideally 0.8:1 to 1:0.8.

It is preferred that the two components (a) and (b) are mixed no more than 10 minutes before application to the surface requiring stain removal.

It is most preferred that the two components (a) and (b) are mixed at the surface requiring stain removal, so that the improved stain removal effect may occur immediately.

In this aspect component (a) may be applied to the surface followed by component (b) or vice versa. Alternatively (and preferably) components (a) and (b) are applied to the surface substantially simultaneously within 30 seconds.

According to a preferred embodiment of the presentation invention, the concentration of hydrogen s peroxide or organic peracid in the composition immediately after mixing is from 0.01 to 10% w/w. This would mean for example in a 1:1 mix of component (a) and (b) that component (a) prior to the mixing would contain from 0.02 to 20% w/w of hydrogen peroxide or an organic peracid.

Where component (a) comprises hydrogen peroxide it is most preferred that the concentration of hydrogen peroxide in the mixture immediately after mixing should be from 1.5 to 5% w/w. For example, if a 1:1 mixture of components (a) and (b) is to be mixed, then component (a) should comprise from 3 to 10% w/w hydrogen peroxide.

The process of the present invention alleviates the need to use further stabilising components for the hydrogen peroxide/organic peracid when preparing commercial products. In addition enzyme activity is maintained for longer periods upon storage and in use.

The components suitable for use in the process according to the invention may further include any other auxiliary ingredients—known to the art. Ideally such auxiliary ingredients are selected from; fragrance, dye, sequesterant, chelating agent, germicide, preservative, corrosion inhibitor, antioxidant or a mixture of any thereof.

The above auxiliary ingredients may be included at concentrations of from 0.01% w/w to 10% w/w. These auxiliary ingredients may be included in either component (a), or component (b) or both if appropriate.

Compositions suitable for use in the process according to the present invention may be stored in any appropriate containers known to the art. For example, the two components may be stored in two-compartment packs suitable for sequential or simultaneous dispensing.

Preferably both components (a) and (b) are liquids, most preferably they-may be stored in a two-compartment dispenser, one compartment containing each component and the dispenser being adapted to dispense each component on to a surface, either sequentially or, preferably, simultaneously.

According to a further aspect of the invention, there is provided A two-compartment dispenser comprising a first compartment containing an aqueous composition comprising hydrogen peroxide or an organic peracid and having a pH of greater than 0 but less than 7:

a second compartment containing an aqueous composition comprising an alkalising agent and;

dispensing means adapted to dispense the contents (or part thereof) of the compartments on to a surface either sequentially or simultaneously to form a mixture thereof; characterised in that components (a) and/or (b) additionally comprise sufficient surfactant, including any super wetting agent, to achieve a surface tension of the combined composition of below 28 mN/m.

Containers

Containers that have at least two compartments are disclosed in the prior art. An example of a two chamber squeezy dispenser is disclosed in U.S. Pat. No. 5,765,725. An example of a gravity driven two chamber dispensing system is disclosed in WO 0185595. An example of a spray dispenser having two liquid compartments is disclosed in EP0479451.

SURFACE TENSION MEASUREMENTS:

The surface tension has been measured with a surface tensiometer, by the ring method. A platinum du Nuoy ring is immersed into a 1:1 ratio mixture of component (a) and component (b) maintained at 20°C. The ring is taken out slowly from the liquid. When the ring is near the air/liquid interface, it is balanced by a tensiometer. The maximum force versus area gained before breaking the liquid film formed is the surface tension of the liquid.

The lower the surface tensions expressed in mN/m, the better the formula performance in terms of wettability on carpet surface.

A surface tension target value for the compositlon is below 28 mN/m.

### Examples

| | | | Mixed Phases |
|---|---|---|---|
| Raw Material | Phase A | Phase B | (50:50 mix) |
| Acrylic Copolymer, 30% - | 2.400 | | 1.200 |
| Syntran 4022 | | | |
| Na Lauryl Sulfate 30% | 4.000 | 2.000 | 3.000 |
| Imino di-succinate | | 2.65-5.00 | 1.33-2.5 |
| Citric acid anhydrous | | 2.500 | 1.250 |
| H2O2, 50% | | 9.660 | 4.830 |
| Dowanol PPH | 0.750 | 0.750 | 0.750 |
| IsoPropyl Alcohol, 98% | 2.000 | 2.000 | 2.000 |
| Fragrance | | 0.300 | 0.150 |
| Sodium Bicarbonate | 5.000 | | 2.500 |
| Preservative | 0.10-0.30 | | 0.05-0.15 |
| Dye | 0.000155 | | 0.00008 |
| Water | 85.850 | 82.790 | 84.320 |
| Total | 100.00 | 100.00 | 100.00 |

1. A process for stain removal on a carpet, comprising applying to the carpet a mixture of at least two components (a) and (b):
(a) an aqueous composition comprising a source of active oxygen having a pH of greater than 0 but less than 7 and
(b) an aqueous composition comprising an alkalizing agent.

2. A process according to claim 1 wherein component (a), component (b) or both components (a) and (b) additionally comprise sufficient surfactant, including any super wetting agent, to achieve a surface tension of the combined composition of below 28 mN/m.

3. A process according to claim 1 wherein component (a), component (b) or both components (a) and (b) additionally comprise a superwetting agent.

4. A process according to claim 2 claim wherein the surfactant is a non-ionic surfactant.

5. A process according to claim 4 wherein component (a) or component (b) additionally contains a polycarboxylate.

6. A process according to claim 1 wherein the pH of component (b) is higher than the pH of component (a).

7. A process according to claim 6 wherein component (a) does not contain a pH buffer.

8. A process according to claim 6 wherein component (b) does contain a pH buffer.

9. A process according to claim 1 wherein component (b) additionally comprises an effervescent agent.

10. A process according to claim 9 claim 9 wherein the effervescent agent is a base or is a peroxide reducing enzyme.

11. A process according to claim 10 wherein the base is a carbonate or a bicarbonate.

12. A process according to claim 10 wherein the surfactant produces a foam upon mixing components (a) and (b).

13. A process according to 12 wherein the foam breaks.

14. A process according to claim 12 wherein the foam reduces in volume by at least 50% in less than 5 minutes of its generation without any form of physical or chemical intervention.

15. A process according to claim 12 wherein surfactant is a non-ionic surfactant of an HLB of greater than 10.

16. A two-compartment dispenser comprising
a first compartment containing an aqueous compositions comprising hydrogen peroxide or an organic peracid and having a pH of greater than 0 but less than 7;
a second compartment containing an aqueous compositions comprising an alkalizing agent and;
dispensing means adapted to dispense the contents (or part thereof) of the compartments on to a surface either sequentially or simultaneously to form a mixture thereof,
characterized in that
components (a) and/or (b) additionally comprise sufficient surfactant, including any super wetting agent, to achieve a surface tension of the combined composition of below 28 mN/m.
